(19) United States
(12) Patent Application Publication
(10) Pub. No.: US 2016/0232756 A1
(43) Pub. Date: Aug. 11, 2016

(54) CURRENCY TRANSPORT MECHANISM

(71) Applicant: Wells Fargo Bank, N.A., San Francisco, CA (US)

(72) Inventor: Alicia Moore, San Ramon, CA (US)

(21) Appl. No.: 14/569,171

(22) Filed: Dec. 12, 2014

Related U.S. Application Data
(60) Provisional application No. 61/935,252, filed on Feb. 3, 2014.

(51) Int. Cl. G07F 19/00

(52) U.S. Cl. CPC G07F 19/205; G07F 19/203; G07F 19/209

(57) ABSTRACT

Systems and methods of conditioning received paper currency are described. The system includes a bill input configured to receive paper currency bills. The system further includes a cassette configured to store received paper currency bills. The system includes a transport mechanism coupled to the bill input and the cassette, the transport mechanism is configured to transport received paper currency bills from the bill input to the cassette. The system further includes a heating element coupled to the transport mechanism or the cassette, the heating element configured to heat the paper currency bills.

### CROSS-REFERENCE TO RELATED PATENT APPLICATIONS

The present application claims priority to U.S. Provisional Application No. 61/935,252, titled “Currency Transport Mechanism” filed Feb. 3, 2014, the entirety of which is herein incorporated by reference.

### BACKGROUND

The present invention relates generally to devices that accept paper currency. Such devices include automated teller machines (“ATMs”), bank teller bill recyclers, vending machines, or any other device configured to accept paper currency. In some cases, such devices may recycle received paper currency. The term “recycling” as used herein refers to receiving paper currency in a first transaction and later dispensing the previously received currency in a second transaction. In other cases, instead of recycling received currency, such devices may deposit and hold received paper currency in a first currency storage cassette and dispense currency from a second currency storage cassette. The second currency storage cassette is typically preloaded in the device by the operator of the device (e.g., a bank). For example, a first user may deposit a currency bill at an ATM. The deposited currency bill is stacked in a first bill cassette in the ATM. Subsequently, a second user may request a cash withdrawal from the same ATM. The ATM completes the cash withdrawal by dispensing an appropriate amount of paper currency from a second cassette that was preloaded with paper currency by the owner of the ATM.

Utilization of currency recycling mechanisms in ATMs and other devices has been limited because not all received currency is appropriate for recycling. Some paper currency includes rips, tears, creases, and other defects that may cause jams within the device during dispensing operations. Accordingly, the owners and operators of the dispensing devices often preload the devices with currency that is deemed “fit” for dispensing. Fit currency is currency that is relatively free of rips, tears, creases, and other defects such that the risk of a jam occurring during a dispensing operation is greatly reduced. The fit currency is dispensed during withdrawal operations.

### SUMMARY

A first exemplary embodiment relates to a currency receiving and dispensing device. The device includes a bill input configured to receive paper currency bills. The device further includes a cassette configured to store received paper currency bills. The device includes a transport mechanism coupled to the bill input and the cassette, the transport mechanism is configured to transport received paper currency bills from the bill input to the cassette. The device further includes a heating element coupled to the transport mechanism or the cassette, the heating element configured to heat the paper currency bills.

### BRIEF DESCRIPTION OF THE FIGURES

The details of one or more implementations are set forth in the accompanying drawings and the description below. Other features, aspects, and advantages of the disclosure will become apparent from the descriptions, the drawings, and the claims, in which:

FIG. 1 is a perspective view of an ATM according to an exemplary embodiment.

FIG. 2 is a schematic diagram of a currency routing mechanism according to an exemplary embodiment.

FIG. 3 is a flow diagram of a method of routing currency in a currency routing device according to an exemplary embodiment.

### DETAILED DESCRIPTION

Numerous specific details may be set forth below to provide a thorough understanding of concepts underlying the described implementations. It may be apparent, however, to one skilled in the art that the described implementations may be practiced without some or all of these specific details. In other instances, some process steps have not been described in detail in order to avoid unnecessarily obscuring the underlying concept.

The following systems and methods relate to devices that recycle received paper currency by dispensing the received paper currency in later transactions. The described systems include mechanisms to condition received paper currency such that the received paper currency becomes fit for recycling. The conditioning may be achieved by heating the received paper currency, steaming the received paper currency, exposing the received paper to pressure, or a combination thereof.

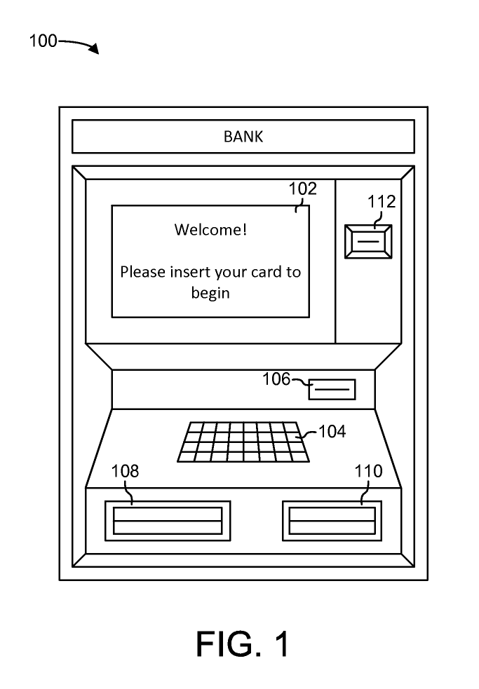

Referring to FIG. 1, a perspective view of an ATM 100 is shown according to an exemplary embodiment. The ATM includes a display 102, a keypad 104, and a card reader 106. ATM 100 is configured to provide a user paper currency during a withdrawal transaction through a paper currency output 108. ATM 100 may be configured to provide multiple denominations of paper currency during the withdrawal transaction. Additionally, ATM 100 is configured to receive paper currency from a user during a deposit transaction through a deposit input (110). ATM 100 may be configured to receive multiple denominations of paper currency during the deposit transaction. ATM 100 includes a printer 112 configured to print receipts of transactions and other records (e.g., bank account statements). During operation, ATM 100 may recycle received paper currency by providing paper currency during a withdrawal transaction that was received in an earlier deposit transaction. ATM 100 is configured to condition received paper currency such that the received paper currency becomes fit for recycling thereby reducing the risk of jams occurring in the currency transport mechanisms within ATM 100. The conditioning is achieved by heating the received paper currency, steaming the received paper currency, exposing the received paper currency to pressure, or a combination thereof as described in further detail below.

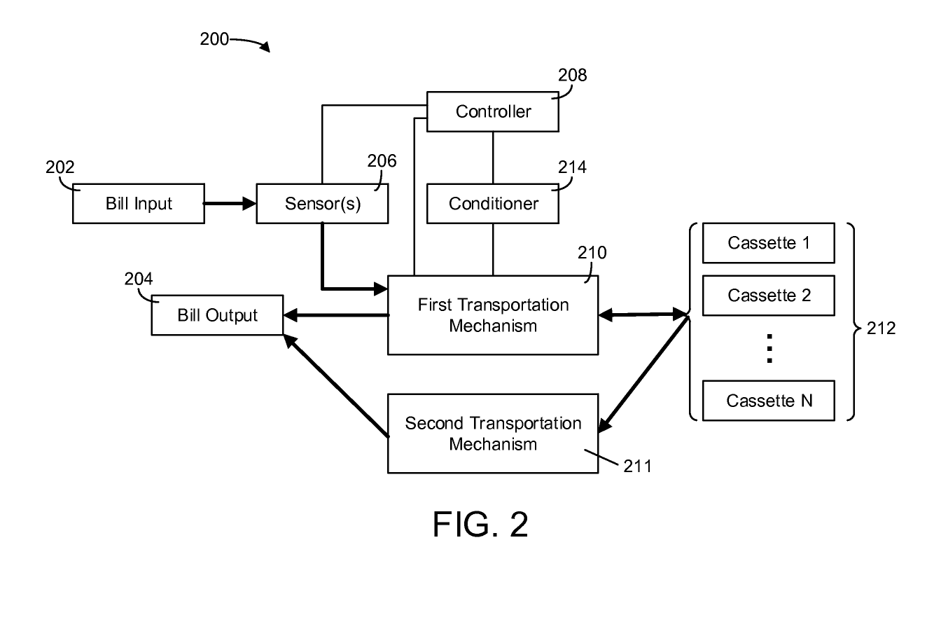

Referring to FIG. 2, a schematic diagram of a paper currency recycling system 200 is shown according to an exemplary embodiment. System 200 may be part of an ATM (e.g., ATM 100), a bank teller bill recycler, a vending machine, or another system configured to receive and output paper currency. The bolded arrows of FIG. 2 represent the paths that paper currency may take within system 200. System 200 is configured to receive paper currency through a bill input 202 and to output paper currency through a bill output 204. In an alternative arrangement, the bill input and bill output may be a single device configured to perform both functions. After being received in the system 200 through the bill input 202, paper currency passes through a sensor 206. The sensor 206 may include a plurality of sensors. The sensor 206 is configured to detect characteristics of the received paper currency and provide feedback signals of the detected characteristics to a controller 208 of the system. The controller 208 is configured to validate the received paper currency as genuine based on analyzing the feedback relating to the detected characteristics received from sensor 206. The detected characteristics may relate to properties of the received paper currency, such as physical properties of the paper currency (e.g., size, weight, conductivity, fluorescent properties, reflective properties, security feature locations, magnetic properties, etc.) and optical properties of the paper currency (e.g., what is printed on the paper currency, the color of the currency, printed security feature attributes, pixel spacing, etc.). The controller 208 may determine a denomination of the received paper currency based on the above recited characteristics. Additionally, the controller 208 may determine a condition of the received paper currency based on the feedback signal relating to detected characteristics of the received paper currency from the sensor 206. The received paper currency may be rejected by the system 200 if the received paper currency is not genuine or if the condition of the received paper currency falls outside of an acceptable range (e.g., if the received paper currency is mutilated).

If the received paper currency is deemed to be genuine and if the condition of the currency is acceptable, a transportation 210 mechanism transports the received currency to one of the cassettes 212. The transport mechanism 210 is coupled to at least one cassette 212. In some arrangements, the system 200 includes a plurality of cassettes (e.g., one cassette for each denomination of accepted paper currency, a cassette for received paper currency that falls within the acceptable condition range but outside of a fit condition for recycling, a cassette that was preloaded with fit currency, etc.). In other arrangements, the system 200 may include a single cassette 212. The transportation mechanism 210 may include rollers, belts, and grippers configured to transport paper currency between the bill input 202, the bill output 204, and the cassettes 212. The transportation mechanism 210 is configured to transport received and accepted paper currency from the bill input 202 to a designated cassette 212 during deposit operations. The transportation mechanism 210 may also be configured to transport paper currency from a designated cassette 212 to the bill output 204 during withdrawal operations. In some arrangements, a second transportation mechanism is configured to transport paper currency from the cassettes 212 to the bill output 204 during withdrawal operations. The transport mechanism 210 may include a flipping mechanism such that received paper currency is stacked in the same direction within a given cassette 212.

The transportation mechanism 210 is coupled to a paper currency conditioner 214. The conditioner 214 selectively performs a conditioning operation on the received paper currency while the received paper currency is transported by transportation mechanism 210. The conditioning operation increases a fit level of the received paper currency. By increasing the fit level of the received paper currency, the received paper currency may be transformed from currency that is not suitable for recycling (i.e., currency that is not capable of being dispensed in a later withdrawal operation) to currency that is suitable for recycling. The conditioning may be achieved at least in part by heating the received paper currency. Accordingly, the conditioner 214 may include a heating element. In some arrangements, the heating element directly heats the received paper currency (i.e., as the received paper currency passes through the transportation mechanism 210, the paper currency passes through the heating element). In other arrangements, the heating element heats components of the transportation mechanism 210 (e.g., a roller or a conveyor), which in turn heat the received paper currency as the paper currency is routed through the transportation mechanism 210. The components of the transportation mechanism 210 that are heated may be metal. In some arrangements, the heating element includes a heat transfer system (e.g., a heat pipe, a heat exchanger, etc.) configured to transport heat from a heat-generating component of the system 200, such as controller 208, to the received paper currency as described above. Heating the received paper currency may remove at least a portion of creases contained within the received paper currency thereby increasing the received paper currency's suitability for recycling. In some arrangements, the transportation mechanism 210 may be configured to exert pressure on the received paper currency during the conditioning operation (e.g., by passing the received currency through opposing rollers or belts). The pressure may also assist in conditioning the received paper currency and increasing the received paper currency's suitability for recycling. In additional arrangements, the conditioner 214 may include a steaming device configured to steam the received paper currency.

Alternatively or additionally, the conditioner 214 may be coupled to at least one of the cassettes 212. Accordingly, received paper currency may be conditioned after the received paper currency is routed to the designated cassette 212. In such an arrangement, a stack of received paper currency in the cassette 212 may be conditioned through heating, steaming, and/or pressure (e.g., the pressure already exerted on the stack of received paper currency by the stacking mechanism associated with the cassette 212).

Cassettes 212 are configured to receive and store paper currency. System 200 may include a single cassette 212 or a plurality of cassettes 212. If the system 200 includes a plurality of cassettes 212, each of the plurality of cassettes may be designated to hold a particular denomination of paper currency. The cassettes 212 may also configured to dispense paper currency during withdrawal operations. At least one cassette of the plurality of cassettes 212 may be configured to only store currency that is not fit for recycling. Each cassette includes a stacking mechanism configured to store paper currency in a stack.

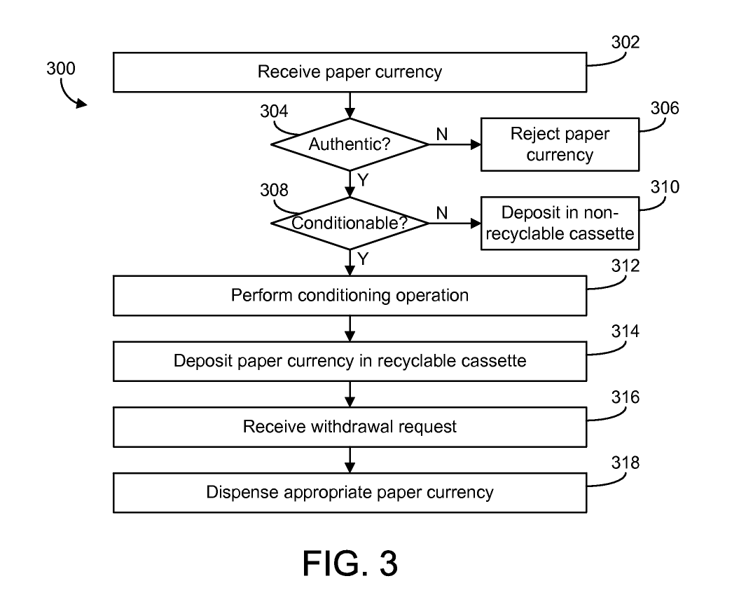

Referring to FIG. 3, a method 300 of receiving and conditioning paper currency for recycling is shown according to an exemplary embodiment. Method 300 may be performed by a device configured to receive and dispense paper currency (e.g., ATM 100, system 200, etc.). Method 300 begins when paper currency is received (302). Paper currency is received via a paper currency input (e.g., deposit input 110, bill input 202, etc.). The paper currency is analyzed to determine whether it is authentic (304). The paper currency is passed through a sensor (e.g., sensor(s) 206). The sensor may include a plurality of sensors. The sensor is configured to detect characteristics of the received paper currency and provide feedback signals of the detected characteristics to a controller of the system. The controller is configured to validate the received paper currency as genuine based on analyzing the feedback relating to the detected characteristics received from sensor. The detected characteristics may relate to properties of the received paper currency, such as physical properties of the paper currency (e.g., size, weight, conductivity, fluorescent properties, reflective properties, security feature locations, magnetic properties, etc.) and optical properties of the paper currency (e.g., what is printed on the paper currency, the color of the currency, printed security feature attributes, pixel spacing, etc.). During the authentication process, the controller may additionally determine a denomination of the received paper currency based on the above recited characteristics. Based on the above-noted characteristics, the controller determines whether the received paper currency is authentic.

If the paper currency is deemed not authentic, then the paper currency is rejected (306). The received currency is rejected by outputting the received currency through the currency input or through a separate currency output.

If the paper currency is deemed authentic, then it is determined whether the paper currency is conditionable into fit currency (308). The controller of the system determines a condition of the received paper currency based on the above discussed feedback signal relating to detected characteristics of the received paper currency from the sensor. Some received paper currency may have a condition that is not suitable for conditioning into recyclable paper currency. For example, the received paper currency may include greater than a threshold number of defects, such as folds, wrinkles, creases, rips, tears, and other defects. Other currency may include less than a threshold number of defects such that the paper currency can be conditioned into fit currency for recycling.

If the paper currency is not conditionable into fit currency, the paper currency is deposited into a cassette that stores non-recyclable paper currency (310). The cassette is configured to receive and store the unfit paper currency. The cassette may include a stacking mechanism. The paper currency is transported to the cassette via a transportation mechanism. The transportation mechanism includes rollers, belts, and/or grippers configured to transport the paper currency between the currency input and the cassette.

If the paper currency is conditionable into fit currency, a conditioning operation is performed on the paper currency (312). The conditioning operation may be performed as the paper currency travels through the transportation mechanism. The conditioning operation increases a fit level of the received paper currency. By increasing the fit level of the received paper currency, the received paper currency may be transformed from currency that is not suitable for recycling (i.e., currency that is not capable of being dispensed in a later withdrawal operation) to currency that is suitable for recycling. The conditioning may be achieved at least in part by heating the received paper currency. Accordingly, a heating element applies heat to the received paper currency. In some arrangements, the heating element directly heats the received paper currency (i.e., as the received paper currency passes through the transportation mechanism, the paper currency passes through the heating element). In other arrangements, the heating element heats components of the transportation mechanism (e.g., a roller or a conveyor of the transportation mechanism), which in turn heat the received paper currency as the paper currency is routed through the transportation mechanism 210. The components of the transportation mechanism that are heated may be metal. In some arrangements, the heating element includes a heat transfer system (e.g., a heat pipe, a heat exchanger, etc.) configured to transport heat from a heat-generating component, such as the controller of the system, to the received paper currency as described above. Heating the received paper currency may remove at least a portion of creases contained within the received paper currency thereby increasing the received paper currency's suitability for recycling. In some arrangements, the transportation mechanism may be configured to exert pressure on the received paper currency during the conditioning operation (e.g., by passing the received currency through opposing rollers or belts). The pressure may also assist in conditioning the received paper currency and increasing the received paper currency's suitability for recycling. In additional arrangements, the conditioning operation may include subjecting the received paper currency to steam from a steaming device.

The conditioned paper currency is deposited into a cassette that stores recyclable paper currency (314). After the conditioning operation, the conditioned paper currency is transported to a designated storage cassette by the transportation mechanism. The cassettes are configured to receive paper currency, store paper currency, and dispense paper currency. Each cassette may be designated to hold a particular denomination of paper currency. Each cassette includes a stacking mechanism configured to store paper currency in a stack. In some arrangements, the conditioning operation may take place after the received paper currency is deposited in the cassette. In such an arrangement, a stack of received paper currency in the cassette may be conditioned through heating, steaming, and/or pressure (e.g., the pressure already exerted on the stack of received paper currency by the stacking mechanism associated with the cassette). Conditioning of the received currency within the cassette may take place in addition to or instead of the above-noted conditioning that takes place during the currency's passage through the transportation mechanism.

A request to withdraw paper currency is received (316). The request may be received at the controller of the system. Paper currency from the cassette storing recyclable paper currency is dispensed (318). The controller instructs the appropriate cassette and the transportation mechanism to dispense the recyclable paper currency from the cassette. The transportation member transports the paper currency from the cassette and to a currency output of the system (e.g., cash output 108, bill output 204, etc.). In some arrangements, a second transportation mechanism is configured to output paper currency while a first transportation mechanism is configured to receive the paper currency.

Although described as being a component of an ATM, the above-described currency routing mechanisms and methods of routing currency may be employed with other devices that recycle paper currency. For example, the above described currency routing mechanism and method of routing currency may be employed with bank teller bill recyclers, vending machines, and the like.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The machine-readable media may be non-transitory machine-readable media. The embodiments of the present invention may be implemented using an existing computer processor, or by a special purpose computer processor incorporated for this or another purpose or by a hardwired system. Machine-executable instructions, associated data structures, and program modules represent examples of program code for executing steps of the methods disclosed herein. The particular sequence of such executable instructions or associated data structures represent examples of corresponding acts for implementing the functions described in such steps.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the designing of the operating conditions and arrangement of the embodiments without departing from the scope of the present invention.

1-13. (canceled)

14. A method for receiving and dispensing paper currency bills, the method comprising:
receiving the paper currency bills into a device;
detecting characteristics of the paper currency bills;
authenticating the paper currency bills based upon the characteristics of the paper currency bills;
assessing a condition of authenticated paper currency bills based upon the characteristics of the paper currency bills;
determining that the condition of a first bill of the authenticated paper currency bills does not permit recycling by determining that the first bill of the authenticated paper currency bills includes greater than a threshold number of defects, wherein the defects include any of folds, wrinkles, creases, rips, or tears;
transferring the first bill of the authenticated paper currency bills to a non-recyclable storage area of the device, the non-recyclable storage area comprising one or more cassettes;
determining that the condition of a second bill of the authenticated paper currency bills permits recycling, applying a first conditioning operation to the second bill of the authenticated paper currency bills;
transferring the second bill of the authenticated paper currency bills to a recyclable storage area of the device, the recyclable storage area comprising one or more cassettes separate from the non-recyclable storage area; and
applying a second conditioning operation to the second bill after the second bill is received within one of the one or more cassettes, the second conditioning operation including heating, steaming, and applying pressure to the second bill received within one of the one or more cassettes.

15. The method of claim 14, further comprising:
receiving a request to withdraw paper currency bills from the device;
retrieving a requested amount of the authenticated paper currency bills from the recyclable storage area of the device; and
dispensing the requested amount of the authenticated paper currency bills from the recyclable storage area of the device.

16. The method of claim 14, wherein the conditioning operation increases the fit level of the paper currency bills.

17. The method of claim 16, wherein the conditioning operation transforms the paper currency bills from currency unsuitable for recycling to currency suitable for recycling.

18-20. (canceled)
